(19) United States
(12) Patent Application Publication
(10) Pub. No.: US 2018/0011920 A1
(43) Pub. Date: Jan. 11, 2018

(54) SEGMENTATION BASED ON CLUSTERING ENGINES APPLIED TO SUMMARIES

(71) Applicant: Hewlett-Packard Development Company, L.P., Fort Collins, CO (US)

(72) Inventor: Steven J SIMSKE, Ft. Collins, CO (US)

(21) Appl. No.: 15/545,048

(22) PCT Filed: Jan. 29, 2015
(86) PCT No.: PCT/US2015/013444

§ 371 Date: Jul. 20, 2017

(51) Int. Cl. G06F 17/30; G06N 99/00

(52) U.S. Cl. CPC G06F 17/30598; G06N 99/005; G06F 17/30011; G06F 17/30554

(57) ABSTRACT

Examples disclosed herein relate to segmentation based on clustering engines applied to summaries. In one implementation, a processor segments text based on a comparison of the output of multiple clustering engines applied to multiple summarizations of documents associated with the text. The processor outputs information related to the contents of the segments.

### BACKGROUND

A computing device may automatically search and sort through massive amounts of text. For example, search engines may automatically search documents, such as based on keywords in a query compared to keywords in the documents. The documents may be ranked based on their relevance to the query. The automatic processing may allow a user to more quickly and efficiently access information.

### BRIEF DESCRIPTION OF THE DRAWINGS

The drawings describe example embodiments. The following detailed description references the drawings, wherein:

FIG. 1 is a block diagram illustrating one example of a computing system to segment text based on clustering engines applied to summaries.

FIG. 2 is a diagram illustrating one example of text segments created based on clustering engines applied to summaries.

FIG. 3 is a flow chart illustrating one example of a method to segment text based on clustering engines applied to summaries.

FIGS. 4A and 4B are graphs illustrating examples of comparing document summary dusters created by different clustering engines.

FIGS. 4C and 4D are graphs illustrating examples of aggregating document summary dusters based on a relationship to a query.

### DETAILED DESCRIPTION

In one implementation, a processor segments text based on the output of multiple clustering engines applied to summaries of documents. For example, the text of the documents may be segmented such that each segment includes documents with similar elements. The different clustering engines may rearrange the summaries differently, and a processor may determine how to aggregate the multiple types of the clustering output applied to the set of documents. For example, a subset of documents may be included within the same cluster by a first clustering engine and in multiple dusters by a second clustering engine, and the processor may determine whether to select the aggregated cluster of the first clustering engine or the individual clusters of the second clustering engine. In one implementation, the summaries used for clustering are from different summarization engines for different documents and/or an aggregation of output from multiple summarization engines for a summary of a single document. Using summarizations may be advantageous because keywords and concepts may be highlighted with less important text disregarded in the clustering process. The combination of the clustering and summarization engines allows for new clustering and/or summarization engines to be seamlessly added such that the method is applied to the output of the newly added engine. For example, the output from a new summarization engine may be accessed from a storage such that the segmentation processor remains the same despite the different output.

The output from the multiple clustering engines may be analyzed based on a comparison of the functional behavior of the summaries within a duster compared to the functional behavior of the summaries in other dusters. The size of the text segments may be automatically determined based on the relevance of the documents summaries in a cluster corresponding to the text segment. For example, the smallest set of clusters from all of the clustering engines may be analyzed to determine whether to combine a subset of them into a single duster. Candidates for combining may be those clusters that are combined by at least one of the other clustering engines. As a result, the dusters may be larger while still indicating a common behavior. Text segments may be created based on the underlying documents within the document summary dusters. The text segments may be used for multiple purposes, such as automatically searching or sequencing.

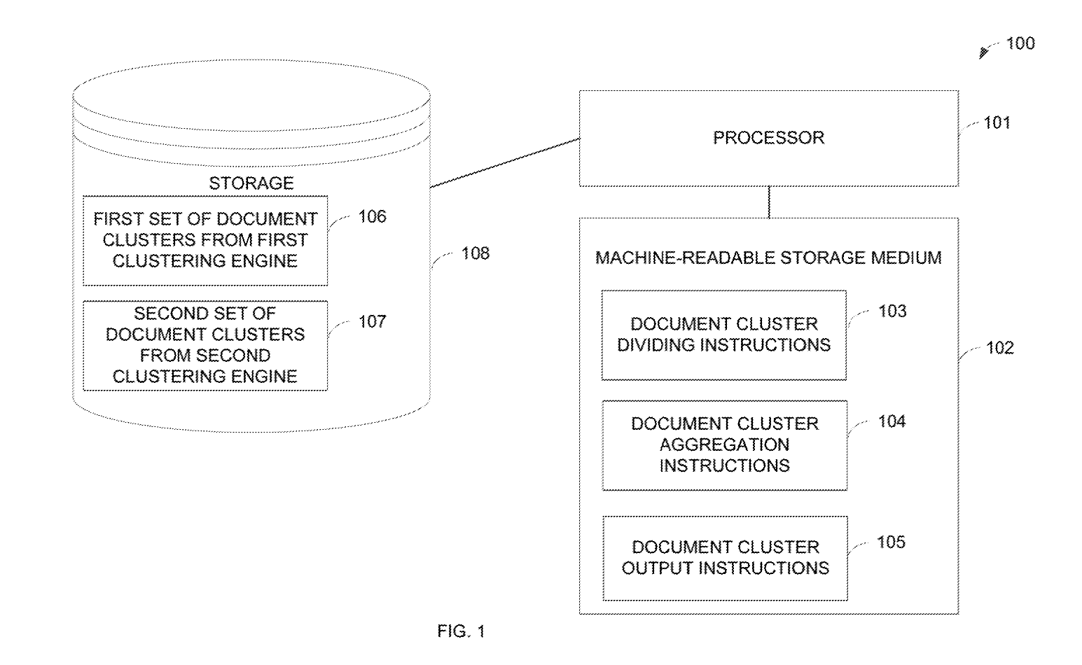

FIG. 1 is a block diagram illustrating one example of a computing system to segment text based on clustering engines applied to summaries. For example, the output of multiple clustering engines applied to a set of document summaries may be used to segment the text within the documents. The text may be segmented such that each segment has a relatively uniform behavior compared to the behavior between the segment and the text in other segments, such as behavior related to the occurrence of terms and concepts within the segment. The computing system 100 includes a processor 101, a machine-readable storage medium 102, and a storage 108.

The storage 108 may be any suitable type of storage for communication with the processor 101. The storage 108 may communicate directly with the processor 101 or via a network. The storage 108 may include a first set of document clusters from a first clustering engine 106 and a second set of document clusters from a second clustering engine 107. In one implementation, there are multiple storage devices such that the different clustering engines may store the set of clusters on different devices. For example, the first clustering engine may be a k-means clustering engine using expectation maximization to iteratively optimize a set of k partitions of data. The second cluster engine may be a linkage-based or connectivity-based clustering where proximity of points to each other is used to determine whether to cluster the points, as opposed to overall variance. In one implementation, the clustering engines may be selected on the data types, such as where a k-means clustering engine is used for a Gaussian data set and a linkage-based clustering is used for a non-Gaussian data set. The document clusters may be created from document summaries, and the document summaries may be created by multiple summarization engines where the output is aggregated. The document summaries may be based on any suitable subset of text, such as where a document for summarization is a paragraph, page, chapter, article, or book. In some cases, the documents may be clustered based on the text in the summaries, but the documents may include other types of information that are also segmented with the process, such as a document with images that are included in a segment that includes the text of the document.

A processor, such as the processor 101, may select a type of clustering engine to apply to a particular type of document summaries. In one implementation, the summary is represented by a vector with entries representing keywords, phrases, topics, or concepts with a weight associated with each of the entries. For example, the weight may indicate the number of times a particular word appeared in a summary compared to the number of words in the summary. There may be some pre- or post-processing so that articles or other less relevant words are not included within the vector. A clustering engine may create dusters by analyzing the vectors associated with the document summaries. For example, the clustering engines may use different methods for determining distances or similarities between the summary vectors.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include document duster dividing instructions 103, document cluster aggregation instructions 104, and document cluster output instructions 105.

Document cluster dividing instructions 103 may include instructions to divide the document summaries into a third set of dusters based on the first set of document dusters 106 and the second set of document clusters 107. For example, the third set of document dusters may be emergent dusters that do not exist as individual clusters output by the individual clustering engines. The output from the clustering engines may be combined to determine a set of clusters, such as the smallest set of dusters from the two sets of documents. For example, a set of documents included in a single cluster by the first clustering engine and included within multiple clusters by the second clustering engine may be divided into the two dusters created by the second clustering engine. In one implementation, the processor 101 applies additional criteria to determine when to reduce the documents into more dusters according to the clustering engine output. The processor 101 also applies additional criteria for the input data characteristics for the clustering engines.

Document duster aggregation instructions 104 include instructions to determine whether to aggregate dusters in the third set of dusters. The dusters may be divided into the greatest number of clusters indicated by the differing cluster output, and the processor may then determine how to combine the multitude of dusters based on the relatedness. For example, the determination whether to aggregate a first cluster and a second cluster may be based on a relevance metric comparing the relatedness of text within the combined first and second dusters compared to the relatedness of the text within the combined first and second duster to a query. For example, if the relatedness (ex. distance) of the document summaries within the combined duster is much less than the relatedness of the duster to a query duster (ex. the distance to the query is greater), the documents may be combined into a single cluster. The query may be a target document, a set of search terms or concepts, or another cluster created by one of the clustering engines. The processor may determine a relevance metric threshold or retrieve a relevance metric threshold from a storage to use to determine whether to combine the documents into a single cluster. A relevance metric threshold may be automatically associated with a genre, class, content or other characteristic associated with a document based on a relevance metric threshold with the best performance as applied to historical and/or training data. In one implementation, dusters that are combined by at least one clustering engine are candidates for combination. In one implementation, candidates for combination are selected based on a distance of a combined vector representative of the summaries within the cluster to a vector of another cluster. For example, the distance may be determined based on a cosine of two vectors representing the contents of the two clusters, and the cosine may be calculated based on a dot product of the vectors.

Document cluster output instructions 104 include instructions to output information related to text segments corresponding to the third set of dusters. For example, information about the dusters and their content may be displayed, transmitted, or stored. Text segments may be created by including the underlying documents of the document summaries included in a cluster. The text segments may be searched or sequenced based on the segments. For example, a text segment may be selected for searching or other operations. As another example, text segments may be compared to each other for ranking or ordering.

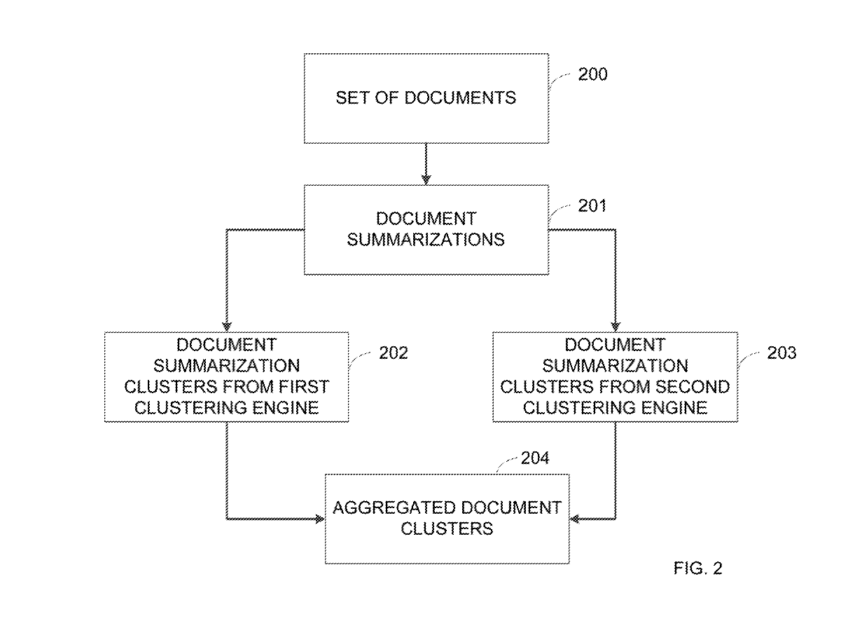

FIG. 2 is a diagram illustrating one example of text segmentation output created based on clustering engines applied to summaries. Block 200 shows an initial set of documents for clustering. The documents may be any suitable type of documents, such as a chapter or book. In some cases, a document may be any suitable segment of text, such as where each sentence, line, or paragraph may represent a document for the purpose of segmentation. The processor may perform preprocessing to select the documents for summarization and/or to segment a group of texts into documents for the purpose of summarization.

Block 201 shows document summarizations of the initial set of documents. Each document may be summarized using the same or different summarization methods. In some cases, the output from multiple summarization methods is combined to create the summary. The summary may be in any suitable format, such as designed for readability and/or a list of keywords, topics, or phrases. In one implementation, a Vector Space Model is used to simply each of the documents into a vector of words associated with weights, and the summarization method is applied to the vectors.

Block 202 represents document summarization dusters from a first clustering engine, and block 203 represents document summarization dusters from a second clustering engine. The different clustering methods may result in the documents being clustered differently. New summarization engines or clustering engines may be incorporated and/or different summarization and clustering engines may be used for different types of documents or different types of tasks. There may be any number of clustering engines used to provide a set of candidate dusters. The method may be implemented in a recursive manner such that the output of a combination of summarizers is combined with the output of another summarizer. Similarly, the clustering engine output may be used in a recursive manner.

Block 204 represents the output from a processor for segmenting text. For example, a processor may consider the clustering output of both engines and determine whether to combine dusters that are combined by one engine but not by another. As one example, dusters included as one duster by both engines may be determined to be a duster. Candidate dusters for combination may be dusters combined by one engine but not another. For example, the processor may perform a tessellation method to break the clustering output into smaller pieces. A relevance metric may be determined for the candidate clusters and a threshold of the metric may be used to determine whether to combine the clusters. The clusters may be output for further processing, such as for searching or ordering. Information about the dusters and their contents may be transmitted, displayed, or stored. In one implementation, the dusters may be further aggregated beyond the output of the clustering engine based on the relevance metric.

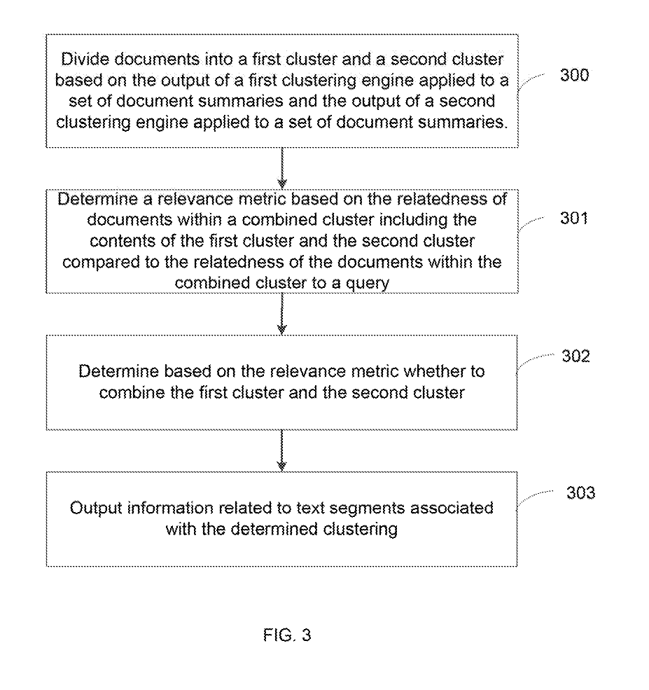

FIG. 3 is a flow chart illustrating one example of a method to segment text based on clustering engines applied to summaries. For example, different clustering engines may be applied to documents summaries, resulting in different clusters of documents. A processor may use the different output to segment the documents by dividing the documents into the smallest set of dusters by the combined clustering engines and determining whether to combine clusters that are combined by one clustering engine. The method may be implemented, for example, by the computing system 100 of FIG. 1.

Beginning at 300, a processor divides documents into a first cluster and a second duster based on the output of a first clustering engine applied to a set of document summaries and the output of a second clustering engine applied to a set of document summaries. For example, a set of documents, such as books, articles, chapters, or paragraphs, may be automatically summarized. The summaries may then serve as input to multiple clustering engines, and the clustering engines may cluster the summaries such that more similar summaries are included within the same duster. The output of the different clustering engines may be different, and the processor may select a subset of the clusters to serve as a starting point for text segments. As an example, the smallest set of clusters by the multiple combined output may be used, such as where two documents are considered in different dusters if any of the clustering engines output them into separate clusters. The document summaries within the first and second duster may be in a single duster from a first clustering engine output and in multiple clusters in a second clustering engine output.

Beginning at 301, determines a relevance metric based on the relatedness of documents within a combined cluster including the contents of the first duster and the second cluster compared to the relatedness of the documents within the combined duster to a query. The query may be, for example, a set of words or concepts. For example, the documents may be segmented based on their relationship to the query, and the segment with the smallest distance to the query may be selected. In some cases, the query may include a weight associated with each of the words or concepts, such as based on the number of occurrences of the word in the query. The query may be a text created for search or may be a sample document. For example, the query may be a document summary of a selected text for comparison. The query may be selected by a user or may be selected automatically. For example, the query may be a selected cluster from the clustering engine output.

In one implementation, a relevance metric is determined for each duster. The relevance metric may reflect the relatedness of documents within the first cluster compared to the relatedness of the documents with the first cluster to a query. The relevance metric may be, for example, an F-score. For example,

$$F + \frac{{MSE}_{b}}{{MSE}_{w}} ,$$

where MSE_{b} is the mean squared error between clusters and MSE_{w} is the mean squared error within a duster. The mean squared error information may be stored for use after segmentation to be used to represent the distance between segments, such as for searching.

The mean squared error may be defined as the sum squared errors (SSE) and the degrees of freedom (df), typically less than 1 in a particular cluster, in the data sets, resulting in:

$$F = \frac{\frac{{SSE}_{b}}{{df}_{b}}}{\frac{{SSE}_{w}}{{df}_{w}}}$$

The mean value of a cluster c (designated μ_{c}) for a data set V with samples Vₛ and a total number of samples n(s) is used to determine MSE as the following:

$${MSE}_{w} = \frac{{\sum }_{c = 1}^{{n}_{c}} {\sum }_{s = 1}^{n ( c )} {( {v}_{s , c} - {μ}_{c} )}^{2}}{{\sum }_{c = 1}^{{n}_{c}} n ( c ) - {n}_{c}}$$

Likewise, mean squared error between clusters may be determined as the following:

$${MSE}_{b} = \frac{{\sum }_{i = 1}^{{n}_{c}} {\sum }_{j = j + 1}^{{n}_{c}} {( {μ}_{i} - {μ}_{j} )}^{2}}{\frac{{n}_{c} ( {n}_{c} - 1 )}{2}} ,$$

And simplified too the following:

$${MSE}_{b} = \frac{{\sum }_{c = 1}^{{n}_{c}} {( {μ}_{c} - {μ}_{μ} )}^{2}}{{n}_{c} - 1}$$

where μ_{μ} is the mean of means (mean of all samples if all of the clusters have the same number of samples).

More simplistically,

$${MSE}_{b} = \frac{{\sum }_{c = 1}^{{n}_{c}} {μ}_{c}^{2} - {n}_{c} {μ}_{c}}{{n}_{c} - 1}$$

$$and$$

$${MSE}_{w} = \frac{{\sum }_{c = 1}^{{n}_{c}} {\sum }_{s = 1}^{n ( c )} {v}_{s , c}^{2} - {\sum }_{c = 1}^{{n}_{c}} n ( c ) {μ}_{c}^{2}}{{\sum }_{c = 1}^{{n}_{c}} n ( c ) - {n}_{c}}$$

As an example, the relevance metric may be determined based on the MSE between the combined first and second cluster and the query (MSE_{b}) compared to the MSE within the combined first and second cluster (MSE_{w}).

Continuing to 302, a processor determines based on the relevance metric whether to combine the first cluster and the second cluster. For example, a lower relevance metric indicating that the distance between clusters (ex. between the combined cluster and the query) is less than the distance within the duster may indicate that the cluster should be split. In one implementation, a threshold for relatedness below which a cluster is not combined may be automatically determined. For example, the processor may execute a machine learning method related to previous uses for searching or sequencing, the thresholds used, and the success of the method. The threshold may depend on additional information, such as the type of documents, the number of documents, the number of clusters, or the type of clustering engines. In one implementation, the processor causes a user interface to be displayed that requests user input related to the relatedness threshold. For example, a qualitative threshold, a numerical threshold, or a desired number of clusters may be received from the user input.

In one implementation, a comparative variance threshold is used between the combined duster and one or more nearby dusters. For example, nearby dusters may be determined based on a distance between summary vectors. Clusters with documents with more variance than nearby clusters may not be selected for combination. For example, a similar method for an F score may be used such that an MSE of a candidate combination duster is compared to an MSE of another nearby cluster. As an example, a relevance metric and the variance metric may be used to determine whether to combine candidate clusters.

Continuing to 303, a processor outputs information related to text segments associated with the determined clustering. For example, the underlying document text associated with the summaries within a cluster may be considered to be a segment. The text segment information may be stored, transmitted, or displayed. The segments may be used in any suitable manner, such as for search or ranking. A segment may be selected based on a query. For example, the distance of the duster to the query, such as based on the combined summary vectors within a cluster compared to the query vector, may be used to select a particular segment. The same distance may be used to rank segments compared to the query. Once a segment is selected, other types of processing may be performed on the text within the selected segment, such as keyword searching or other searching within the segment. In one implementation, processing, such as searching, may occur in parallel where the action is taken simultaneously on each segment.

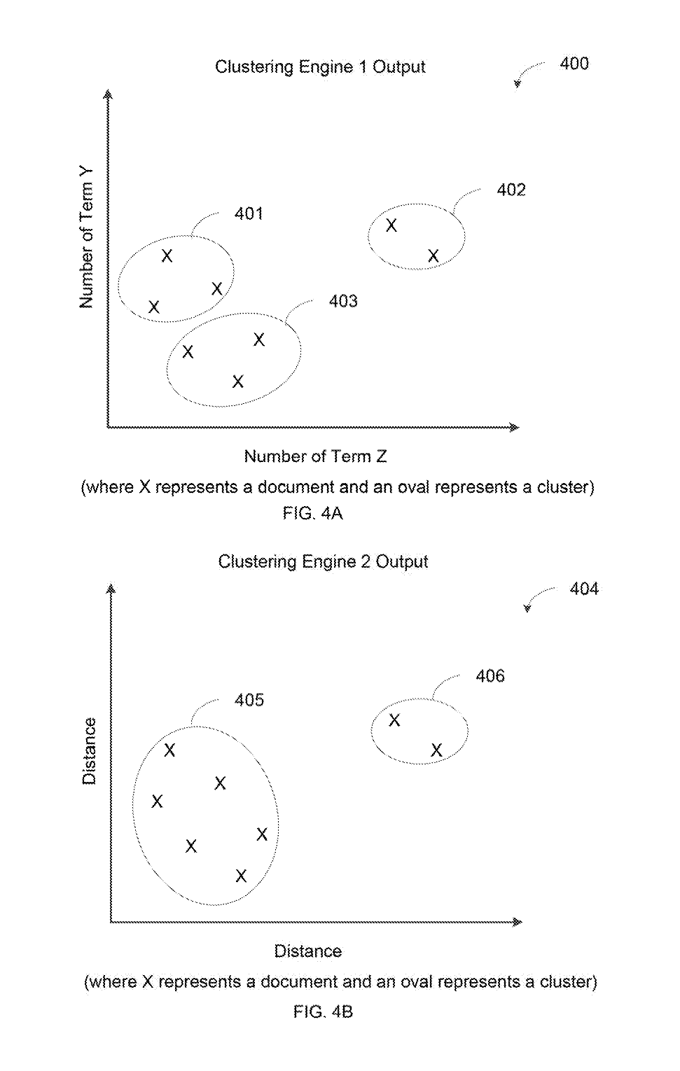

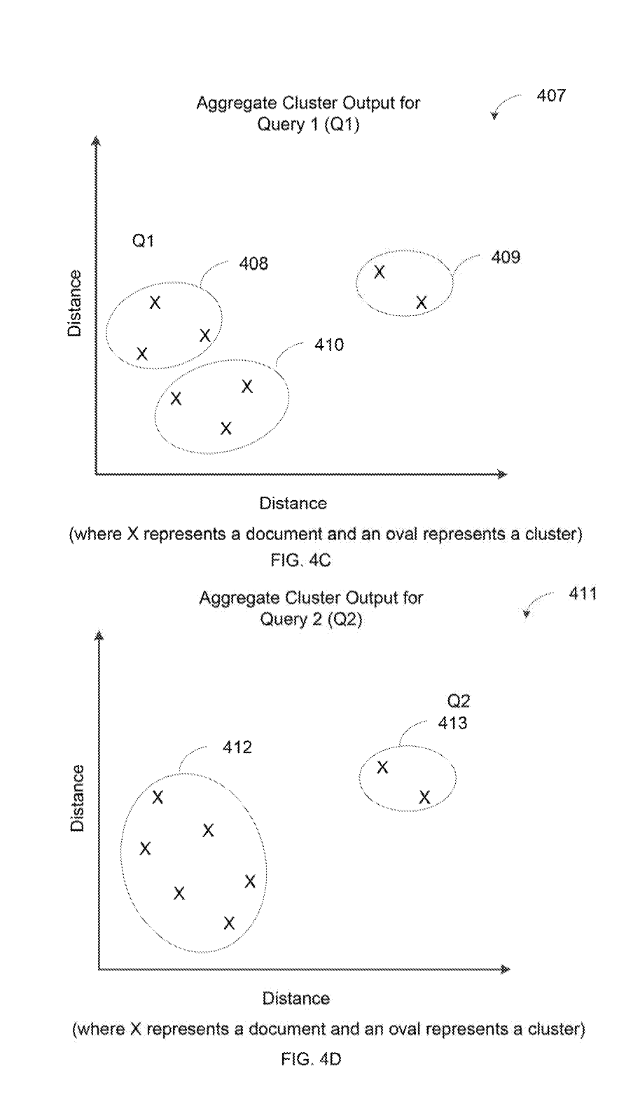

FIGS. 4A and 4B are graphs illustrating examples of comparing document summary dusters created by different clustering engines. FIG. 4A shows a graph 400 for comparing the concentration of terms Y and Z in multiple summarizations of documents shown with the clustering from a first clustering engine. For example, a set of query terms may include terms Y and Z, and the query may include a number of each term, and the query terms may be compared to the contents of the summarizations in the clusters. FIG. 4A shows the output of a first clustering engine applied to the set of document summaries where each summary is represented by X. The position of an X within the graph is related to the weight of the Y term in the summary and the weight of the Z term in the summary. The weight may be determined by the number of times the term appears, the number of times the term appears in relation to the total number of terms, or any other comparison of the terms within the summary. The first clustering engine clustered the document summaries into three dusters, cluster 401, cluster 402, and duster 403.

FIG. 4B is a diagram illustrating one example of a graph 404 for comparing the concentration of terms Y and Z in multiple summarizations of documents shown with the clustering output of a second clustering engine. For example, the X document summaries are shown in the same positions in the graph 400 and 404, but the clusters resulting from the two different clustering engines are different. The second clustering engine clustered the documents into two clusters, cluster 405 and 406, compared to the three clusters output from the first clustering engines. The cluster 406 corresponds to the duster 402 and includes the same two document summaries. The six document summaries in the duster 405 are divided into two dusters, dusters 401 and 403, by the first clustering engine.

FIGS. 4C and 4D are graphs illustrating examples of aggregating document summary dusters based on a relationship to a query. FIG. 4C shows a graph 407 representing aggregating clustering output compared to a first query. For example, the relatedness score may be based on the relatedness within the duster to the relatedness of the cluster to the query. A processor may determine a relatedness score for clusters 401 and 403 to determine whether to combine them into a cluster similar to duster 405. The query Q1 is near the dusters such that the relatedness to Q1 is likely to be close to the relatedness within duster 401 and within cluster 403, resulting in a lower relatedness score, such as the F score described above, and indicating that the clusters should not be combined, leaving three separate clusters 408, 409, and 410.

FIG. 4D shows a graph 411 representing aggregating clustering output compared to a second query. A processor may determine a relatedness score for clusters 401 and 403 to determine whether to combine them into cluster similar to duster 405. The query Q2 is farther from the dusters 401 and 403 such that a relatedness score indicates that the distance to the query is greater compared to the distance of the documents within the potential combined duster. The duster is a selected for aggregation, resulting in a single duster 412 and a second duster 413.

Once candidates for combination are analyzed, the underlying text segments associated with the summaries in each duster may be grouped together, and operations may be performed on the individual segments and/or to compare the different segments. Using summaries and multiple clustering engine output may result in more cohesive and useful segments for further processing.

1. A computing system, comprising:
a storage to store:
information related to a first set of clusters of documents output from a first clustering engine applied to summarizations of the documents; and
information related to a second set of clusters of the documents output from a second clustering engine applied to the summarizations; and
a processor to:
divide the document summaries into a third set of clusters based on the output of the first clustering engine and the second clustering engine;
determine whether to aggregate dusters in the third set of dusters, wherein determining whether to aggregate a first cluster and a second cluster is based on a relevance metric comparing the relatedness of text within the combined first and second clusters compared to the relatedness of the text within the combined first and second cluster to a query; and
output information related to text segments corresponding to the third set of clusters.

2. The computing system of claim 1, wherein determining whether to aggregate a first duster and a second cluster is further based on a comparison of a variance between documents within the combined first and second cluster and the variance between documents in a different cluster.

3. The computing system of claim 1, wherein the processor determines a threshold of the relevance metric for aggregation based on a machine learning method.

4. The computing system of claim 1, wherein the processor is further to cause a user interface to be displayed to allow a user to input information related to a relevance metric threshold for aggregation.

5. The computing system of claim 1, wherein the processor is further to perform at least one of: select a cluster in the third set of clusters based on the query and sequence a subset of the clusters in the third set of dusters based on the query.

6. A method, comprising:
dividing, by a processor, documents into a first duster and a second cluster based on the output of a first clustering engine applied to a set of document summaries and the output of a second clustering engine applied to a set of document summaries;
determining a relevance metric based on the relatedness of documents within a combined cluster including the contents of the first cluster and the second cluster compared to the relatedness of the documents within the combined cluster to a query;
determining based on the relevance metric whether to combine the first duster and the second cluster; and
outputting information related to text segments associated with the determined clustering;

7. The method of claim 6, further comprising determining whether to combine the first and second cluster based on a comparison of the variance between document summaries within the combined first and second duster and the variance between document summaries in a different duster.

8. The method of claim 6, further comprising determining a relevance metric threshold for combining the clusters based on a comparison of the relevance metric of clusters previously combined.

9. The method of claim 6, further comprising receiving a relevance metric threshold for combining the clusters from user input provided to a user interface.

10. The method of claim 6, further comprising determining duster candidates for combination based on documents clustered into a single cluster by the first clustering engine and clustered into multiple dusters by the second clustering engine.

11. A machine-readable non-transitory storage medium with instructions executable by a processor to:
segment text based on a comparison of the output of multiple clustering engines applied to summarizations of documents associated with the text; and
output information related to the contents of the segments.

12. The machine-readable non-transitory storage medium of claim 11, wherein instructions to determine the contents of a duster of documents comprises instructions to determine whether to aggregate clusters where the clusters are combined by a first one of the clustering engines but not by a second one of the clustering engines.

13. The machine-readable non-transitory storage medium of claim 12, further comprising instructions to determine whether to aggregate the dusters based on a comparison of the relationship of documents within a duster to a relationship of the documents within the duster to a query.

14. The machine-readable non-transitory storage medium of claim 13, further comprising instructions to cause a user interface to be displayed to receive user input related to information about the relationship for clustering.

15. The machine-readable non-transitory storage medium of claim 11, further comprising instructions to perform at least one of document searching and document ordering based on the output information.
